(19) United States
(12) Patent Application Publication
(10) Pub. No.: US 2004/0005818 A1
(43) Pub. Date: Jan. 8, 2004

(54) Solenoid connector

(76) Inventors: Kerry J. Judge, Safety Harbor, FL (US); Timo E. Rantikallio, Langshyttan (SE)

Correspondence Address: FOWLER WHITE BOGGS BANKER, P.A., 501 E. KENNEDY BOULEVARD, SUITE 1700, TAMPA, FL, 33602, US

(21) Appl. No.: 10/610,219

(22) Filed: Jun. 30, 2003

Related U.S. Application Data
(60) Provisional application No. 60/392,764, filed on Jul. 1, 2002.

(51) Int. Cl. H01R 25/00

(52) U.S. Cl. 439/638

(57) ABSTRACT

The present invention discloses a device for electrically connecting an external device into a circuit running from an apparatus control switch, to an apparatus, thus allowing the interception and redirection of the control signal to the external device. It concerns a simple, completely enclosed, error-proof connector which allows for simultaneous operation of the apparatus and the external device.

### CROSS-REFERENCE TO RELATED APPLICATION

The present application claims the benefit of previously filed co-pending Provisional Patent Application, Serial No. 60/392,764.

### FIELD OF THE INVENTION

The present invention relates to the field of electrical connections. More specifically, it relates to a device for electrically connecting an external device into a circuit running from an apparatus control switch, to an apparatus, thus allowing the interception and redirection of the control signal to the external device. It concerns a simple, completely enclosed, error-proof connector which allows for simultaneous operation of the apparatus and the external device.

### BACKGROUND OF THE INVENTION

In the equipment control industry, it is common for an apparatus having a solenoid to be controlled by an apparatus control switch. A typical configuration is shown in FIG. 1. In normal operation, a user controls the operation of apparatus 83 by activating apparatus control switch 60, which causes an electrical signal to be sent to apparatus solenoid 80 which then acts upon apparatus 83.

Typically, such an apparatus control switch 60 is connected to apparatus solenoid 80 by either a three-pin or four-pin connection. For example, an apparatus solenoid 80 may have a three-pin male connector which inserts into the three-pin female connector of apparatus control switch 60, as shown in FIG. 1. In the three-pin female connector of apparatus control switch 60, there is included a “hot pin” 60A, often referred to as a “#1 pin” by those familiar in the art; a “ground” pin 60B, often referred to as a “#2 pin”; located directly across from the hot pin on the same side of the connector; and a “line-up” pin 60C located between the hot pin and the ground pin, for use in lining up the female pins of apparatus control switch 60 with the male pins of apparatus solenoid 80. A typical apparatus 83 will include an apparatus solenoid 80, which has three male pins, where such pins 80A, 80B and 80C line up and provide for electrical and mechanical connection with the female pins 60A, 60B, and 60C, respectively, of apparatus control switch 60.

An alternative to the typical three-pin prior art connection is a four-pin arrangement, depicted in FIG. 2. In a four-pin arrangement, apparatus control switch 160 includes four female connections, including: (1) a “hot” pin 160A, known as a #1 pin; (2) a ground pin 160B, often denoted as a #2 pin; (3) a “dead” pin 160C, typically referred to as a “#3 pin”; and (4) a line-up pin 160D. As with the three-pin connection, there are usually four male pins on an apparatus solenoid 180, and such pins include pins 180A-180D which are lined up to be inserted into apparatus control switch female pins 160A-160D.

When it is desired to operate only the apparatus, the above standard connections serve quite adequately. There are many instances, however, in which it may be desirable to intercept the control signal that is sent from the apparatus control switch to the apparatus solenoid, and redirect that signal to another destination, such as an external appliance or measuring device, before such signal is sent back to the apparatus to be operated upon. For example, it may be advantageous to operate an external appliance simultaneously with the apparatus. In such a situation, a means of intercepting the control signal allows for simultaneous operation is needed. Likewise, it may be advantageous to introduce a delay in the signal from the apparatus operator to the apparatus by means of an external timer. Other reasons for intercepting and redirecting such a signal include measuring the strength or reliability of the control signal and other purposes well known in the art.

In order to introduce an external device into the path of the control signal, it is typical in the prior art to use a series of individual wires, where a “hot wire” is connected from the apparatus control switch hot pin to the “hot” side of the external device, and a “ground wire” from the ground of the external device to the “ground pin” on the apparatus solenoid. However, such an arrangement leaves all such individual wires exposed, thus creating a hazardous situation. Moreover, such connections are not protected from the elements or from being knocked loose by mechanical shock, which is not only inconvenient but also potentially dangerous.

To overcome such problems, a solenoid connector of a present invention is disclosed. Such a connection is typically safely and effectively made by using a standard three-pin or four-pin solenoid connector, as shown in FIGS. 3-4.

### OBJECTS AND SUMMARY OF THE INVENTION

It is an object of the present invention to disclose a simple device which allows the user of an apparatus to intercept the signal between the apparatus control switch and the apparatus, and re-route that control signal to an external device.

### BRIEF DESCRIPTION OF THE DRAWINGS

The invention will now be described, with respect to the drawings in which:

FIG. 1 depicts the male and female pin configurations of typical 3-pin solenoid connectors.

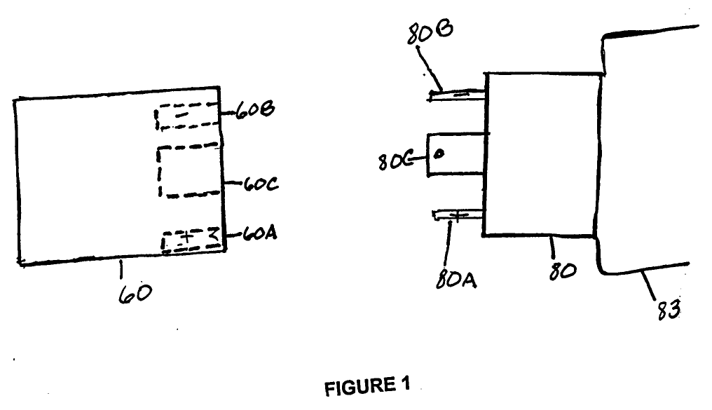

FIG. 2 depicts the male and female pin configurations of typical 4-pin solenoid connectors.

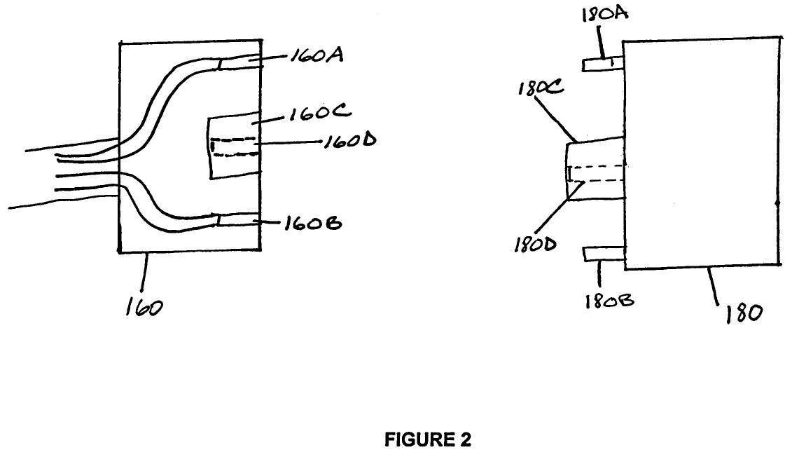

FIG. 3 depicts a top view showing the 3-pin solenoid connector of the present invention aligned to connect to typical 3-pin connections.

FIG. 4 depicts a top view showing the 4-pin solenoid connector of the present invention aligned to connect to typical 4-pin connections.

FIG. 5 depicts a view of the pin shapes of a typical 4-pin solenoid connector.

### DESCRIPTION OF THE PREFERRED EMBODIMENT

The present invention will now be described more fully hereinafter with reference to the accompanying drawings, in which preferred embodiments of the invention are shown. It will be understood that the components of the presently preferred embodiments of the present invention, as generally described and illustrated in the figures herein, could be arranged and designed in a wide variety of different configurations. Thus, this invention may be embodied in many different forms and should not be construed as limited to the embodiments set forth herein. Rather, these embodiments are provided so that this disclosure will be thorough and complete, and will fully convey the scope of the invention to those skilled in the art, and will be merely representative of the presently preferred embodiments of the invention. Like reference characters indicate corresponding parts throughout the several views of the drawings.

The present invention includes a novel solenoid connector. In its most basic form, it is a device for connecting two apparatuses. It is also an electrical connection device for simultaneous control of two appliances. It also relates to an electrical connection device for connecting a remote appliance into a circuit between a control switch and a device to be controlled. It is also an electrical connector for intercepting a control signal to an apparatus and redirecting the signal to a remote device before returning the signal to the device. It is also an electrical connector to be introduced into a circuit between a control switch for operating an apparatus and the apparatus to be operated, where such electrical connector intercepts the signal from the control switch and redirects the signal to a remote appliance before returning the signal to the device to be controlled.

### EXAMPLE 1

Three-Pin Connector

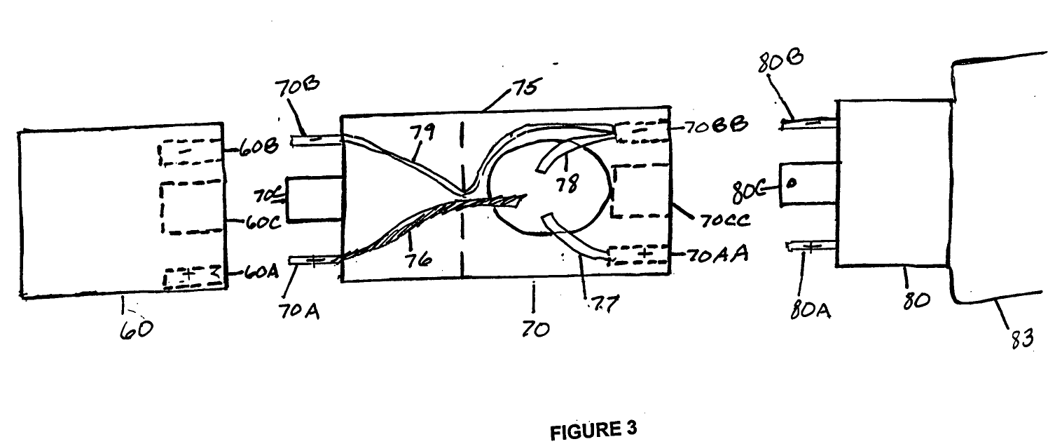

In the preferred embodiment of the present invention, there is included a novel three-pin solenoid connector, such as depicted in FIG. 3 and designated as 70 having a first side including three male pins and a second side including three female pins. On the first side, the following male pins are included: (1) first male pin, or “hot pin,” 70A; (2) second male pin, or “ground” pin, 70B; and (3) third male pin, or “line-up” pin, 70C, all of which are located in the configuration typically found on three-pin solenoid as discussed above.

Also included on novel solenoid connector 70 are three female pins, including first female pin, or “hot pin,” 70AA, second female pin, or “ground” pin, 70BB, and third female pin, or “line-up” pin 70CC, all of which are located in the configuration typically found on three-pin solenoid connectors, as depicted in FIG. 3. In such a configuration, the female pins are configured to accept the male pins 80A-80C of a typical apparatus solenoid 80.

Attached to the external casing 75 of connector 70 is a cord (not shown). Within the cord are electrical conductors, such as electrical wires, which allow for the transfer of electrical signals received by male pins 70A-70C to be transferred to a remote location, and then to be returned to the female pins 70AA-70CC of the novel solenoid connector of the present invention.

In the preferred embodiment of the three-pin unit of the present invention, cord 76 contains hot feed wire, 76; second conductor, or hot return wire, 77, and third conductor, or ground wire, 78. Hot feed wire 76 is in electrical connection on one end with hot pin 70A. The other end of hot feed wire 76 is exposed in the preferred embodiment, allowing for field connection to any external device or other item located remotely from apparatus 83. Hot return wire 77 is in electrical connection with female hot pin 70AA on one end, and may be exposed on the other end, allowing for field connection to any external device or other item. Next, ground wire 78 is in electrical connection with female ground pin 70BB on one end, and may be exposed on the other end, thus allowing for field connection with the ground terminal of any remote apparatus or other device. Finally, located within external casing 75 is a direct ground wire 79. By virtue of direct ground wire 79, male ground pin 70B is in electrical connection with female ground pin 70BB.

With respect to the three-pin connector, except where noted, there is no direct connection between a male pin on the first side of the connector and a correspondingly located female pin in the preferred embodiment. This is in contrast to the four-pin connector, described below, in which each male pin on the one side of the connector extends directly through the connector and is in mechanical and electrical connection with the corresponding female slot on the other side of the connector. More specifically, the male pins of the three-pin unit do not extend through the center of the connector body, but instead rely on conductors, such as wiring, for any connections which may exist between a male pin and a female pin. However, where appropriate, a male pin could extend through the connector body to the corresponding female pin, for example, as may be appropriate for the connection between male pin 70B and female pin 70BB.

It should be noted that the third male pin, 70C, is not in electrical contact with third female pin 70CC.

### EXAMPLE 2

Four-Pin Connector

As discussed in the Background section, it is also common in the industry for the connection between apparatus control switch 60 and apparatus solenoid 80 to utilize four pins, rather than three. As such, an alternative embodiment of the solenoid connector of the present invention likewise has four terminals on each side. The physical and electrical configuration of the four-pin unit, however, differs in several respects from the three-pin connector.

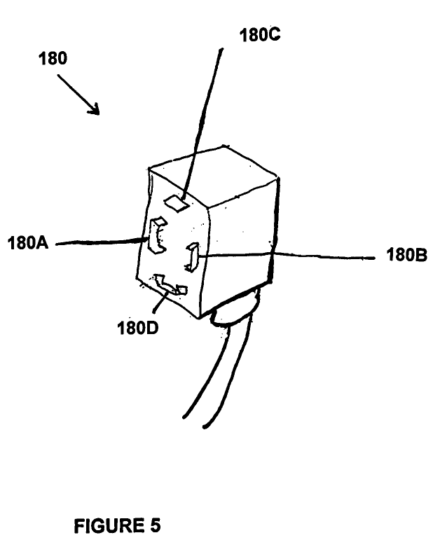

The standard industry connections which utilize four-pin connectors are depicted in FIG. 5. As can be seen with reference to FIG. 5, a standard control switch and a standard solenoid connector typically have three prongs which are slightly curved inward, and a fourth prong which is straight. In addition, the straight pin is also wider than a typical curved pin. As a result of these differences, there is a reduced likelihood that a user will connect an apparatus control switch to an apparatus solenoid in any manner other than as intended by the manufacturer.

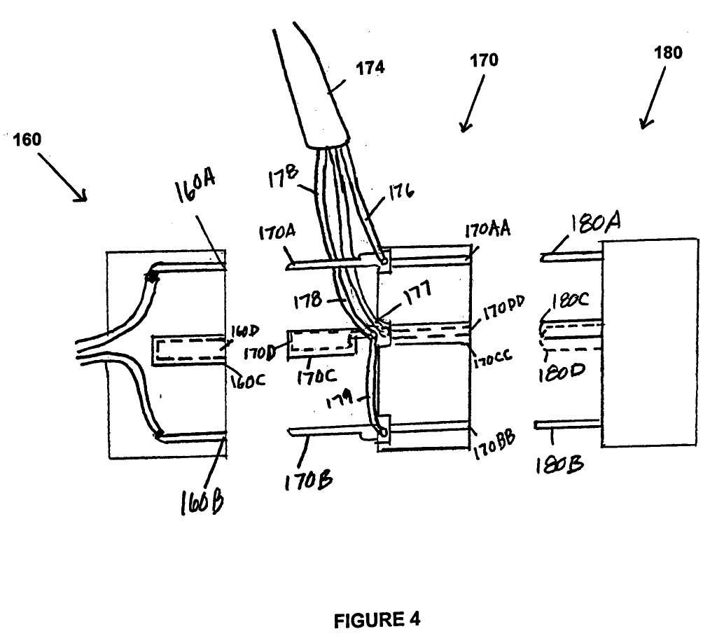

The preferred embodiment of the present connector takes into account these differences, as shown in FIG. 4. Specifically, one of the male and female terminals are physically straight, while the remaining six prongs have a slight curve inward. This configuration likewise results in a connector that cannot be incorrectly connected. As a result, a user is prevented from incorrectly connecting the solenoid connector 80 to either the apparatus control switch or the apparatus solenoid.

In addition to having a pin configuration that prevents the four-pin unit from being connected improperly, there is another safety feature which serves to reduce the likelihood that a user will mistakenly attempt to use a three-pin connector when a four-pin connector is called for. Specifically, the casing of the three-pin connector of the preferred embodiment is rectangular, whereas the casing of the four-pin connector is square. Such casing shapes are also standard in the industry for three- and four-pin connections. As a result, users will immediately know by its shape whether a given connector is the appropriate embodiment for a given application.

In the four-pin embodiment of the present invention, as depicted in FIG. 4 and designated generally as 170, there is a connector body for those skilled in the art (not shown for ease of disclosing the electrical connections) having a first side including four male pins and a second side including four female pins. On the first side are the following male pins: (1) first male pin, or “hot” pin,” 170A; (2) second male pin, or “ground” pin, 170B; (3) third male pin, or “line-up” pin, 170C; and (4) fourth male pin, or “dead” pin, 170D. All four of the male pins of solenoid connector 170 are configured so as to be insertable into corresponding female pins 160A-160D of a typical four-pin apparatus control switch 160. It should be noted that FIG. 4 is a side view or top view, as opposed to a perspective view, and as such those elements of the present invention which are blocked from view by other elements that are closer to the viewer are shown by dashed lines and slightly offset. For example, element 170D is lined up adjacent to element 170C in the preferred embodiment, but element 170D is shown in dashed lines and slightly offset as compared to element 170C in FIG. 4. A similar depiction is utilized to better illustrate element 180D, which is adjacent to 180C in the preferred embodiment.

Also included on novel solenoid connector 170 are four female pins, including first female pin, or “hot pin,” 170CC; second female pin, or “ground” pin, 170DD; third female pin, or “line-up” pin, 170BB; fourth female pin, or “dead” pin, 170AA. It should be noted that by virtue of the male pins extending through the body of the connector and being in contact with the corresponding female pin on the opposite side of the connector, each male pin is in electrical and physical contact with the corresponding female pin. In other words, male pin 170A is in electrical contact with female pin 170AA, male pin 170B is in electrical contact with female pin 170BB, male pin 170C is in electrical contact with female pin 170CC, and male pin 170D is in electrical contact with female pin 170DD.

Attached to the external casing (not shown) of connector 170 is cord 174. Within cord 174 are electrical conductors, such as electrical wires, which allow for the transfer of electrical signals received by male pins 170A-170D to be transferred to a remote location, and then to be returned to the female pins 170AA-170DD of the novel solenoid connector of the present invention, as described herein.

In the preferred embodiment of the four-pin unit of the present invention, cord 174 contains hot feed wire 176, hot return wire 177, and ground wire 178. Hot feed wire 176 is in electrical connection on one end with first male pin 170A, and therefor also in electrical connection with first female pin, or “dead” pin, 170AA. The other end of hot feed wire 176 may be exposed in the preferred embodiment, allowing for field connection to any apparatus or other device located remotely from apparatus 183.

Next, hot return wire 177 is in electrical connection with male straight pin 170C on one end, and therefor also in electrical connection with female hot pin 170CC. The other end of hot return wire 177 may be exposed on the other end, allowing for field connection to any remote apparatus or other device.

Next, ground wire 178 is in electrical connection with male dead pin 170D on one end, and therefor is also in electrical connection with female pin 170DD. The other end of ground wire 178 may be exposed, thus allowing for field connection with the ground terminal of any remote apparatus or other device. Finally, located within external casing (not shown) is a direct ground wire 179 connecting male ground pin 170B to male dead pin 170D, which by virtue of the male pins of the present embodiment being connected to the correspondingly located female pins, results in ground wire 179 also being in electrical connection with female straight pin 170BB and female ground pin 170DD.

Both the three-pin and four-pin embodiments may work with a variety of electrical systems, such as, for example, solenoids operating on either 12 or 24 volts, and systems employing these or other voltages fall within the scope of the present invention.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that modifications and embodiments are intended to be included within the scope of the dependent claims. It should be noted that the various elements of the present invention may be used to achieve the purposes described herein alone or in combination. Also, it should be noted that neither a device to be controlled or the solenoid associated with such device, nor an external apparatus to be included in the circuit created by the present invention, are intended to be claimed elements of the present invention, but such references are only intended to describe the context in which the invention is used, and not the structure of the present invention.

What is claimed is:

1. An electrical device for electrically connecting an external device between an apparatus control switch and an apparatus, where the apparatus control switch includes female pin electrical connections and the apparatus includes male pin connections, such electrical device comprising:
(a) a first male pin;
(b) a second male pin;
(c) a third male pin;
(d) a fourth male pin
(e) said first male pin, said second male pin, said third male pin, and said forth male pin being electrically connectable to the female pins of the apparatus control switch;
(f) a first female pin;
(g) a second female pin;
(h) a third female pin;
(i) a fourth female pin;
(j) said first female pin, said second female pin, said third female pin, and said forth female pin being electrically connectable to the male pins of the apparatus;
(k) said first male pin being in electrical connection with said first female pin;
(l) said second male pin being in electrical connection with said second female pin;
(m) said third male pin is being in electrical connection with said third female pin;
(n) said fourth male pin being in electrical connection with said fourth female pin;
(o) a first conductor;
(p) said first conductor being in electrical connection with said first male pin and electrically connectable to the external device;
(q) a second conductor;
(r) said second conductor being in electrical connection with said third male pin and electrically connectable to the external device;
(s) a third conductor;
(t) said third conductor being in electrical connection with said fourth male pin and electrically connectable to the external device;
(u) a fourth conductor; and
(v) said fourth conductor being in electrical connection with said fourth male pin and said second male pin.

2. The electrical device of claim 1, wherein the apparatus control switch and the apparatus each have an energized pin, a ground pin, a line-up pin, and a dead pin, said electrical device further comprising:
(a) said first male pin being electrically connectable to the energized female pin of the apparatus control switch;
(b) said second male pin being electrically connectable to the ground female pin of the apparatus control switch;
(c) said third male pin being electrically connectable to the female line-up pin of the apparatus control switch;
(d) said fourth male pin being electrically connectable to the female dead pin of the apparatus control switch;
(e) said first female pin being electrically connectable to the female dead pin of the apparatus;
(f) said second female pin being electrically connectable to the male line-up pin of the apparatus;
(g) said third female pin being electrically connectable to the male energized pin of the apparatus; and
(h) said fourth female pin being electrically connectable to the male ground pin of the apparatus.

3. The electrical device of claim 2, further comprising:
(a) said first male pin, said second male pin, and said fourth male pin comprising a pin width cross-section that is curved on either end;
(b) said third male pin comprising a pin width cross-section that is generally straight;
(c) said first female pin, said third female pin, and said fourth female pin comprising a pin width cross-section that is curved on either end; and,
(d) said second female pin comprising a longitudinal cross-section that is generally straight.

4. The electrical device of claim 3, further comprising:
(a) a casing;
(b) said casing having at least a first side and a second side;
(c) said first male pin, said second male pin, said third male pin and said fourth male pin being located on said casing first side; and
(d) said first female pin, said second female pin, said third female pin and said fourth female pin being located on said casing second side.

5. The electrical device of claim 4, wherein:
(a) said first male pin is “hot” pin;
(b) said second male pin is a “ground” pin;
(c) said third male pin is a “line-up” pin;
(d) said fourth male pin is a “dead” pin;
(e) said first female pin is a “dead” pin;
(f) said second female pin is a “line-up” pin;
(g) said third female pin is a “hot” pin; and
(h) said fourth female pin is a “dead” pin.

6. The electrical device of claim 5, wherein:
(a) said first conductor, said second conductor, and said third conductor comprise electrical wiring; and,
(b) said cord is rubber.

7. The electrical device of claim 6, further comprising:
(a) said fourth conductor comprising wiring.

8. The electrical device of claim 7, further wherein said casing is substantially water-resistant.

9. An electrical device for electrically connecting an external device between an apparatus control switch and an apparatus, where the apparatus control switch includes female pin electrical connections and the apparatus includes male pin connections, such electrical device comprising:
(a) a first male pin;
(b) a second male pin;
(c) a third male pin;
(d) said first male pin and said second male pin being electrically connectable to the female pins of the apparatus control switch;
(e) said second male pin being mechanically connectable to a female pin of the apparatus control switch;
(f) a first female pin;
(g) a second female pin;
(h) a third female pin;
(i) said first female pin and said second female pin being electrically connectable to the male pins of the apparatus;
(j) said third female pin being mechanically connectable to a male pin on the apparatus;
(k) a first conductor;
(l) said first conductor being in electrical connection with said first male pin and electrically connectable to the external device;
(m) a second conductor;
(n) said second conductor being in electrical connection with said second female pin and being electrically connectable to the external device;
(o) a third conductor;
(p) said third conductor being in electrical connection with said first female pin and being electrically connectable to the external device; and
(q) said second male pin being in electrical connection with said second female pin;

10. The electrical device of claim 9, wherein the apparatus control switch and the apparatus each have an energized pin, a ground pin, and a line-up pin, said electrical device further comprising:
(a) said first male pin being electrically connectable to the energized female pin of the apparatus control switch;
(b) said second male pin being electrically connectable to the ground female pin of the apparatus control switch;
(c) said third male pin being mechanically connectable to the female line-up pin of the apparatus control switch;
(d) said first female pin being electrically connectable to the female energized pin of the apparatus;
(e) said second female pin being mechanically connectable to the male ground pin of the apparatus; and
(f) said third female pin being mechanically connectable to the male line-up pin of the apparatus.

11. The electrical device of claim 10, further comprising:
(a) said first male pin, said second male pin, said third male, said first female pin, said second female pin, and said third female pin comprising a pin width cross-section that is generally straight.

12. The electrical device of claim 11, further comprising:
(a) a casing;
(b) said casing having at least a first side and a second side;
(c) said first male pin, said second male pin, and said third male being located on said casing first side; and
(d) said first female pin, said second female pin, and said third female being located on said casing second side.

13. The electrical device of claim 12, wherein:
(a) said first male pin is “hot” pin;
(b) said second male pin is a “ground” pin;
(c) said third male pin is a “line-up” pin;
(d) said first female pin is a “hot” pin;
(e) said second female pin is a “ground” pin;
(f) said third female pin is a “line-up” pin; and

14. The electrical device of claim 13, wherein:
(a) said first conductor, said second conductor, and said third conductor comprise electrical wiring; and,
(b) said cord is rubber.

15. The electrical device of claim 14, further comprising:
(a) a fourth conductor;
(b) said fourth conductor being in electrical connection with said second male pin and said second female pin;
(c) said fourth conductor comprising wiring.

16. The electrical device of claim 15, further wherein said casing is substantially water-resistant.
